(19) United States
(12) Patent Application Publication
(10) Pub. No.: US 2026/0361009 A1
(43) Pub. Date: Nov. 12, 2026

(54) Header Assembly

(71) Applicant: TE Connectivity Solutions GmbH, Schaffhausen (CH)

(72) Inventors: Vinay K C, Bangalore (IN); Raghunandan SHANBHAG, Bangalore (IN); Dinesh Loku HEMNANI, Winston Salem, NC (US); Madan Kumara MUDAGRE CHANDRA Kumara, Bangalore (IN)

(73) Assignee: TE Connectivity Solutions GmbH, Schaffhausen (CH)

(21) Appl. No.: 19/250,343

(22) Filed: Jun. 26, 2025

(30) Foreign Application Priority Data
May 9, 2025 (IN) 202541045047

(51) Int. Cl. H01R 9/22; H01R 9/24; H01R 43/18

(52) U.S. Cl. CPC H01R 9/223; H01R 9/24; H01R 43/18

(57) ABSTRACT

A header assembly includes a backing plate, a locking clip having an attachment section attached to the backing plate, and a header. The backing plate has a base and a terminal block extending from the base. The locking clip has a clip arm extending away from the attachment section. The header is disposed on the base around the terminal block of the backing plate. The clip arm of the locking clip releasably engages the header to attach the header to the backing plate in a locked position.

### CROSS-REFERENCE TO RELATED APPLICATION

This application claims the benefit of the filing date under 35 U.S.C. § 119(a)-(d) of Indian Provisional Patent Application No. 202541045047, filed on May 9, 2025.

### FIELD OF THE INVENTION

The present invention relates to an electrical connector and, more particularly, to a header assembly.

### BACKGROUND OF THE INVENTION

A header type of electrical connector is commonly attached to and extends from an interface plate for mating with a mating connector. Generally, the header is attached to a side of the interface plate with a plurality of fasteners, such as bolts, that extend through threaded holes of the header and into the interface plate. Alternatively, the header can be latched to the interface plate by plastic latches.

These current forms of attachment of the header to the interface plate have deficiencies that impair both the assembly efficiency and long-term use of the header. The bolts require significant effort in assembly, while the plastic latches are not robust and cannot provide a high retention force over an extended service life, which can lead to unreliable connections. Further, these common forms of attachment do not permit the header to be removed from the interface plate from the mating end of the header, requiring a complicated disassembly and increasing difficulty in maintenance, for example in replacing components of the header.

### SUMMARY OF THE INVENTION

A header assembly includes a backing plate, a locking clip having an attachment section attached to the backing plate, and a header. The backing plate has a base and a terminal block extending from the base. The locking clip has a clip arm extending away from the attachment section. The header is disposed on the base around the terminal block of the backing plate. The clip arm of the locking clip releasably engages the header to attach the header to the backing plate in a locked position.

### BRIEF DESCRIPTION OF THE DRAWINGS

The invention will now be described by way of example with reference to the accompanying Figures, of which:

FIG. 1 is a perspective view of a header assembly according to an embodiment;

FIG. 2 is a perspective view of a backing plate of the header assembly;

FIG. 3 is a perspective view of a locking clip of the header assembly;

FIG. 4 is a sectional side view of the backing plate taken along line 4-4 of FIG. 2, with the locking clip attached to the backing plate;

FIG. 5 is a sectional side view of the backing plate taken along line 5-5 of FIG. 2, with the locking clip attached to the backing plate;

FIG. 6 is a sectional perspective view of the header assembly taken along line 6-6 of FIG. 1, with an interface plate and a header of the header assembly removed;

FIG. 7 is a perspective view of the backing plate with the locking clip attached prior to assembly of the interface plate;

FIG. 8 is a sectional perspective view of the backing plate taken along line 8-8 of FIG. 2, with the interface plate attached to the backing plate in a latched position;

FIG. 9 is a front view of the backing plate with the locking clip attached and the interface plate attached in the latched position, prior to assembly of the header; and

FIG. 10 is a sectional side view of the header assembly in a locked position, taken along line 6-6 of FIG. 1.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “assembly direction”, “transverse direction”, and “width direction”. These descriptors are merely for clarity of the description and for differentiation of the various directions. These directional descriptors do not imply or require any particular orientation of the disclosed elements.

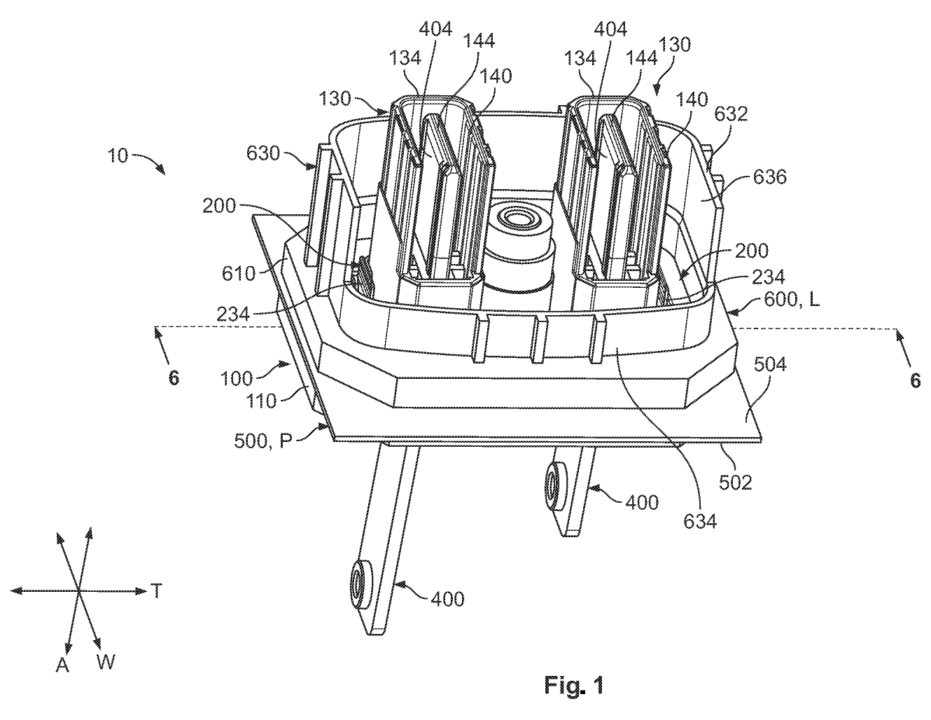

A header assembly 10 according to an embodiment is shown in a locked position L in FIG. 1. The header assembly 10 includes a backing plate 100, a pair of locking clips 200 attached to the backing plate 100, a header 600 attached to the backing plate 100 by the locking clips 200, and an interface plate 500 disposed between the backing plate 100 and the header 600.

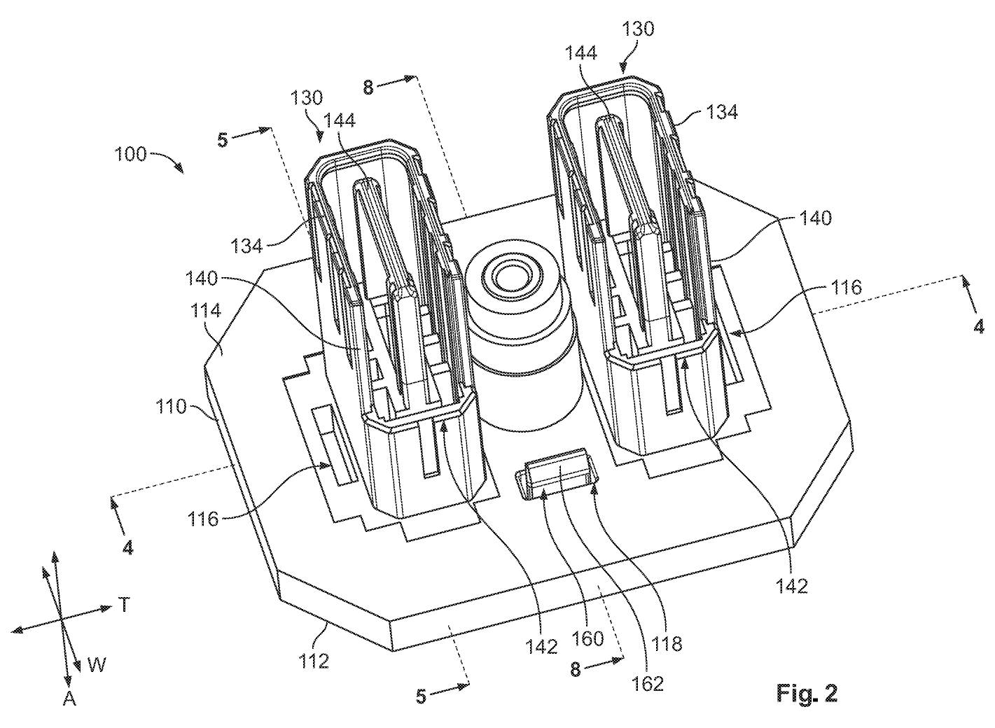

The backing plate 100, as shown in FIGS. 1 and 2, includes a base 110 and a pair of terminal blocks 130 extending from the base 110 along an assembly direction A. The base 110 has a first side 112 and a second side 114 opposite the first side 112 in the assembly direction A.

As shown in FIGS. 2, 4, 6, and 8, the base 110 has a pair of clip passageways 116 and a pair of latch passageways 118 extending through the base 110 in the assembly direction A. Each of the clip passageways 116 and each of the latch passageways 118 extends fully through the base 110 from the first side 112 to the second side 114. The clip passageways 116 are positioned on opposite sides of the terminal blocks 130 along a transverse direction T perpendicular to the assembly direction A. The latch passageways 118 are positioned on opposite sides of the terminal blocks 130 along a width direction W perpendicular to the assembly direction A and perpendicular to the transverse direction T.

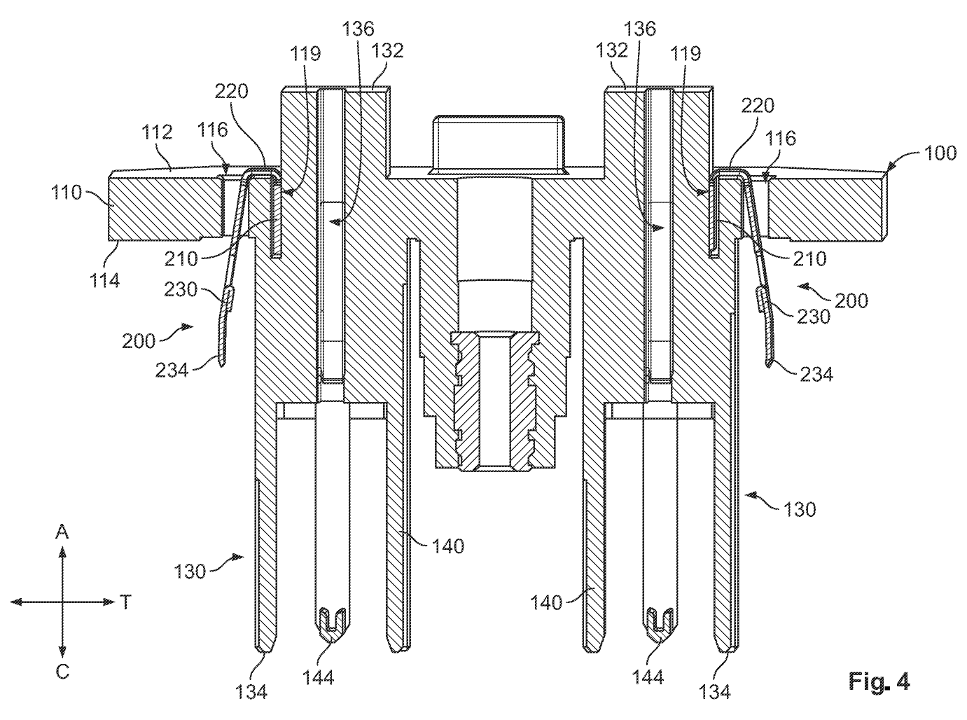

The base 110, as shown in FIGS. 4-6, has a pair of clip recesses 119 extending into the first side 112 of the base 110 along the assembly direction A. The clip recesses 119 do not extend fully through the base 110 to the second side 114 in the shown embodiment. The clip recesses 119 are each positioned adjacent to one of the clip passageways 116, are parallel to the clip passageways 116 and, in the shown embodiment, are both positioned between the clip passageways 116 along the transverse direction T.

The terminal blocks 130 each extend from a first end 132 extending from the first side 112 of the base 110 to a second end 134 extending from the second side 114 of the base 110 in the assembly direction A, as shown in FIGS. 1, 2, and 4. The terminal blocks 130 each define a terminal receiving passageway 136 extending along the assembly direction A and have a terminal shroud 140 at the second end 134. The terminal shroud 140 of each of the terminal blocks 130, in the embodiment shown in FIG. 2, has an open side 142 facing in the width direction W. The terminal blocks 130 each have a touch protection 144 positioned within the terminal shroud 140 that surrounds the terminal receiving passageway 136.

As shown in FIGS. 2, 5, and 8, the backing plate 100 has a pair of latches 160 that each extend into one of the latch passageways 118. The latches 160, in the shown embodiment, each have a latch arm 162 that extends from the first side 112 of the base 110 through one of the latch passageways 118 to a latch protrusion 164 that is disposed at a free end of the latch arm 162. The latch protrusion 164 is positioned above the second side 114 of the base 110. The latch arm 162 is resiliently deflectable within the latch passageway 118 along the width direction W.

The backing plate 100 is formed from an insulative material, such as a plastic. In the shown embodiment, the backing plate 100 is monolithically formed in a single piece from the insulative material; the base 110, the terminal blocks 130, and the latches 160 are monolithically formed in a single piece as the backing plate 100. In other embodiments, the base 110, the terminal blocks 130, and the latches 160 may be formed as separate pieces assembled together to form the backing plate 100 as described herein.

In the shown embodiment, the backing plate 100 has two clip passageways 116, two latch passageways 118, two clip recesses 119, two terminal blocks 130, and two latches 160. In other embodiments, the number of each of these components may be different than in the shown embodiment, and may be one, three, or more, provided that the number of clip passageways 116 corresponds to the number of clip recesses 119, and the number of latch passageways 118 corresponds to the number of latches 160. In other embodiments, the clip passageways 116, the latch passageways 118, the clip recesses 119, the terminal blocks 130, and the latches 160 may be arranged differently than in the particular embodiment shown and described herein, provided that these components can perform the connection functions described in detail below.

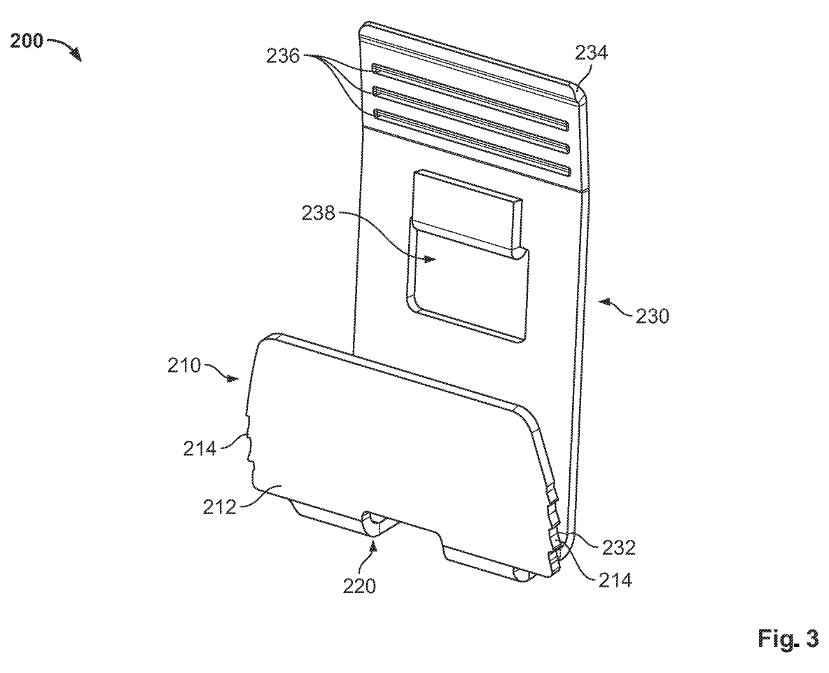

One of the locking clips 200 is shown in detail in FIG. 3. The locking clip 200 has an attachment section 210, a connection section 220 extending from the attachment section 210, and a clip arm 230 extending from an end of the connection section 220 opposite the attachment section 210. The attachment section 210 has a tab 212 that is a flat section having an outer shape that tapers from the connection section 220 to an end of the attachment section 210. In the shown embodiment, the tab 212 has a plurality of serrations 214 on a pair of opposite sides of the tab 212. The connection section 220, in the shown embodiment, is a pair of webs connecting the attachment section 210 and a connected end 232 of the clip arm 230. In other embodiments, the connection section 220 may be any structure formed of the materials of the locking clip 200 described herein and capable of connecting the attachment section 210 and the connected end 232 of the clip arm 230.

The clip arm 230, as shown in FIG. 3, is cantilevered and extends from the connected end 232 to a free end 234 opposite the connected end 232. The clip arm 230 is angled at the free end 234 and, in the shown embodiment, has a plurality of ridges 236 that protrude from one of the surfaces of the clip arm 230 adjacent the free end 234. In another embodiment, the ridges 236 on the clip arm 230 can be omitted. The clip arm 230 has a locking opening 238 between the connected end 232 and the free end 234 that extends through the clip arm 230.

The locking clip 200 is monolithically formed in a single piece from a material that is different than the backing plate 100. The locking clip 200 is formed from an elastically deformable material that resists plastic deformation, such as a metal material. In an embodiment, the locking clip 200 is cut and bent from a sheet metal material. In another embodiment, the locking clip 200 could be formed from a plurality of pieces of the metal material and assembled together to form the locking clip 200 described herein.

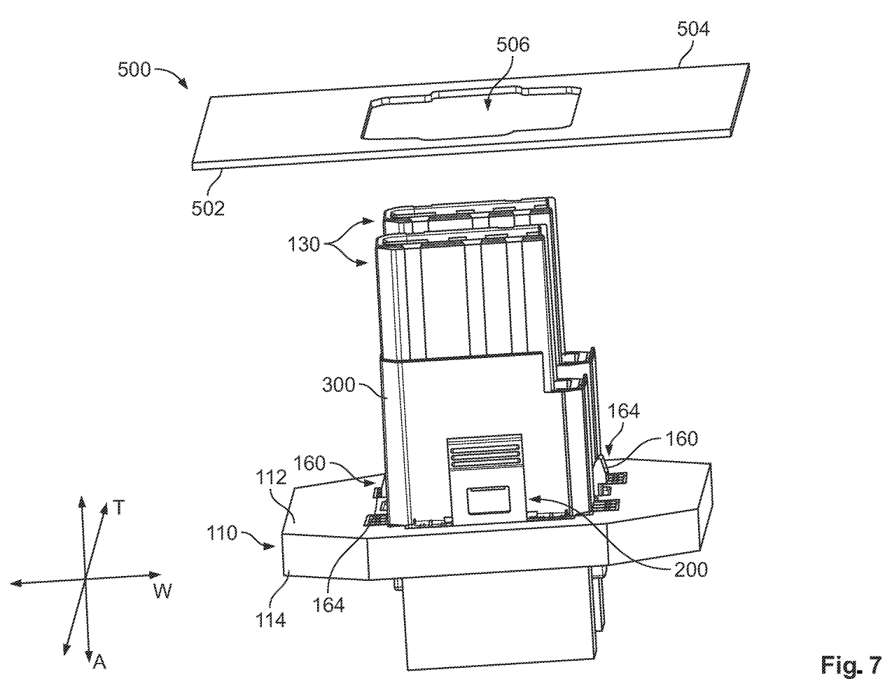

The interface plate 500, shown in FIGS. 1 and 7, is a sheet material that has a first face 502 and a second face 504 opposite the first face 502 in the assembly direction A. The interface plate 500 has a plate opening 506 extending through the interface plate 500 along the assembly direction A. In an embodiment, the interface plate 500 is a sheet metal material. In other embodiments, the interface plate 500 may be any type of material to which a header connector is attachable.

The header 600, as shown in FIGS. 1, 9, and 10, includes a flange 610, a header shroud 630 extending from the flange 610, and a seal 650 positioned within the flange 610. In another embodiment, the terminal blocks 130 described above could be part of the header 600 instead of part of the backing plate 100.

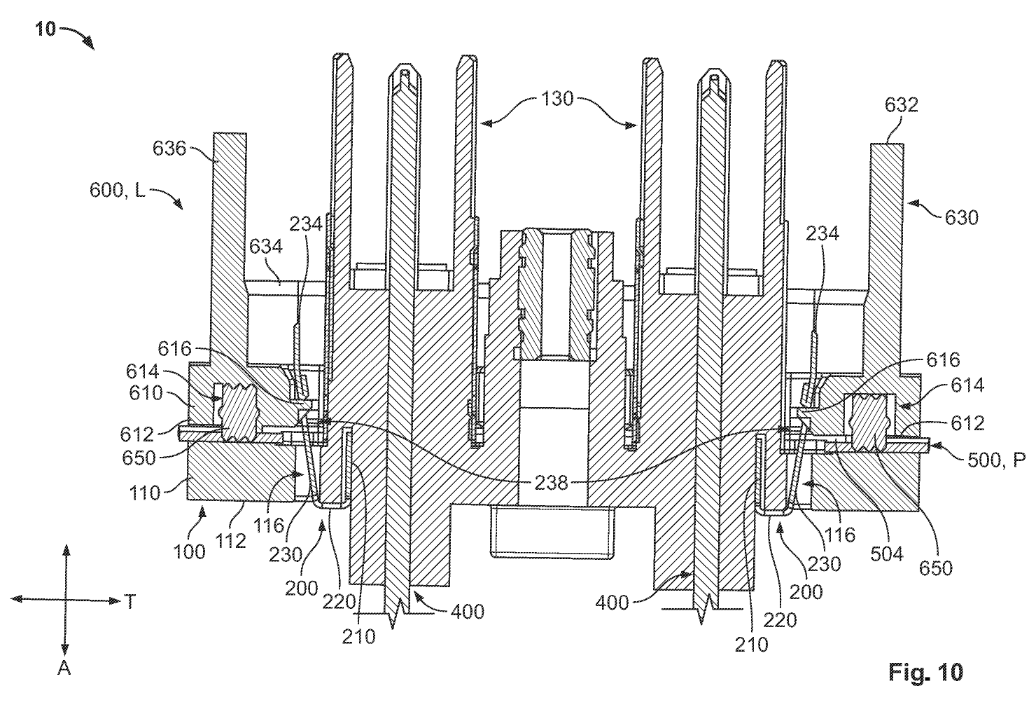

The flange 610, as shown in FIG. 10, has a bottom face 612 with a seal recess 614 extending into the bottom face 612 along the assembly direction A. The seal recess 614 extends around a perimeter of the flange 610. The flange 610 has a pair of protrusions 616 positioned opposite one another and extending inwardly from the flange 610 along the transverse direction T.

The header shroud 630, as shown in FIGS. 1, 9, and 10, extends from a side of the flange 610 opposite the bottom face 612 to a mating end 632 in the assembly direction A. The header shroud 630 has a thickness in the transverse direction T that is less than a thickness of the flange 610. The header shroud 630 includes a first section 634 on a side of the header shroud 630 and a second section 636 forming the other sides of the header shroud 630; the second section 636 extends further than the first section 634 along the assembly direction A.

The flange 610 and the header shroud 630 are formed of an insulative material, such as a plastic. In the shown embodiment, the flange 610 and the header shroud 630 are monolithically formed in a single piece from the insulative material. In another embodiment, the flange 610 and the header shroud 630 can be formed from a plurality of pieces of the insulative material that are assembled together.

The seal 650 of the header 600, as shown in FIG. 10, is disposed in the seal recess 614 and extends around a perimeter of the flange 610. The seal 650 is formed of an elastomeric material, such as silicone, rubber, or any other material used in seals.

The assembly of the header assembly 10 will now be described in greater detail primarily with reference to FIGS. 4-10.

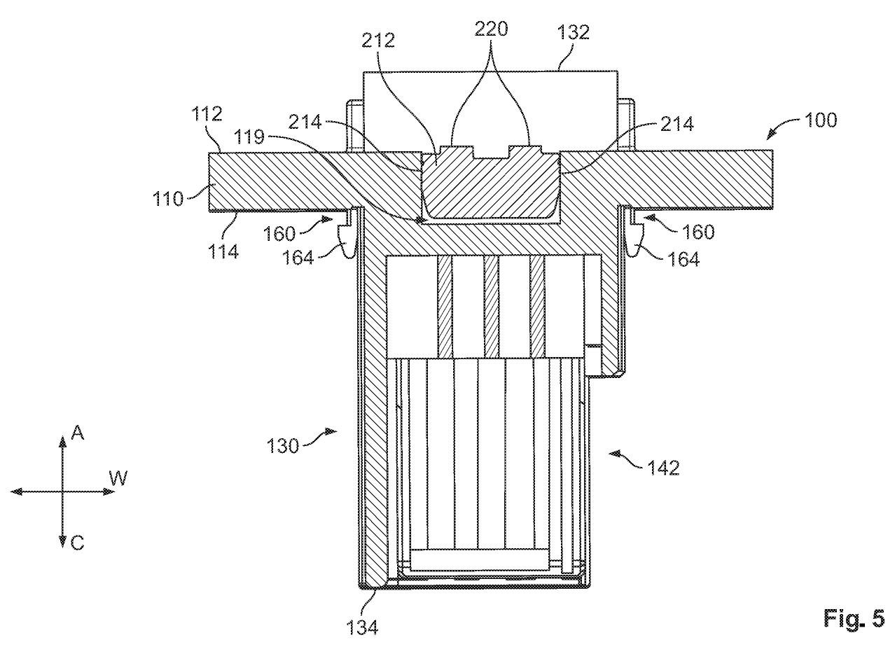

The locking clip 200 is inserted into the backing plate 100 as shown in FIGS. 4 and 5. The backing plate 100 is shown inverted in FIGS. 4 and 5 to illustrate the insertion direction of the locking clips 200 described herein, but could also be positioned in other orientations during insertion of the locking clips 200.

The locking clips 200 are inserted into the base plate 100 along a clip direction C that is parallel and counter to the assembly direction A. As shown in FIG. 4, the free end 234 of the clip arm 230 of the locking clip 200 is inserted into one of the clip passageways 116 along the clip direction C. The attachment section 210 of the locking clip 200 is inserted into one of the clip recesses 119 along the clip direction C. The locking clip 200 is moved in the clip direction C until, as shown in FIG. 4, the connection section 220 abuts and extends around the first side 112 of the base 110, and the clip arm 230 extends away from the attachment section 210 through the clip passageway 116 of the base 110. The free end 234 of the clip arm 230 and the locking opening 238 of the clip arm 230 are positioned beyond the second side 114 of the base 110.

When the locking clip 200 is fully inserted, as shown in FIG. 5, the tab 212 of the attachment section 210 is press-fit into one of the clip recesses 119 to attach the locking clip 200 to the backing plate 100 on the first side 112 of the base 110. The tab 212, including the serrations 214, is slightly wider than the opening of the clip recess 119 in the width direction W and, when pressed into the clip recess 119, the sides of the tab 212 and the serrations 214 engage the base 110 bordering the clip recess 119 in the width direction W to secure the locking clip 200 to the backing plate 100.

In the shown embodiment, the header assembly 10 has two locking clips 200, with one locking clip 200 inserted into one of the clip passageways 116 and engaging one of the clip recesses 119 of the base 110. In other embodiment, the number of locking clips 200 in the header assembly 10 may be different, provided that the number of locking clips 200 corresponds to the number of clip passageways 116 and the number of clip recesses 119.

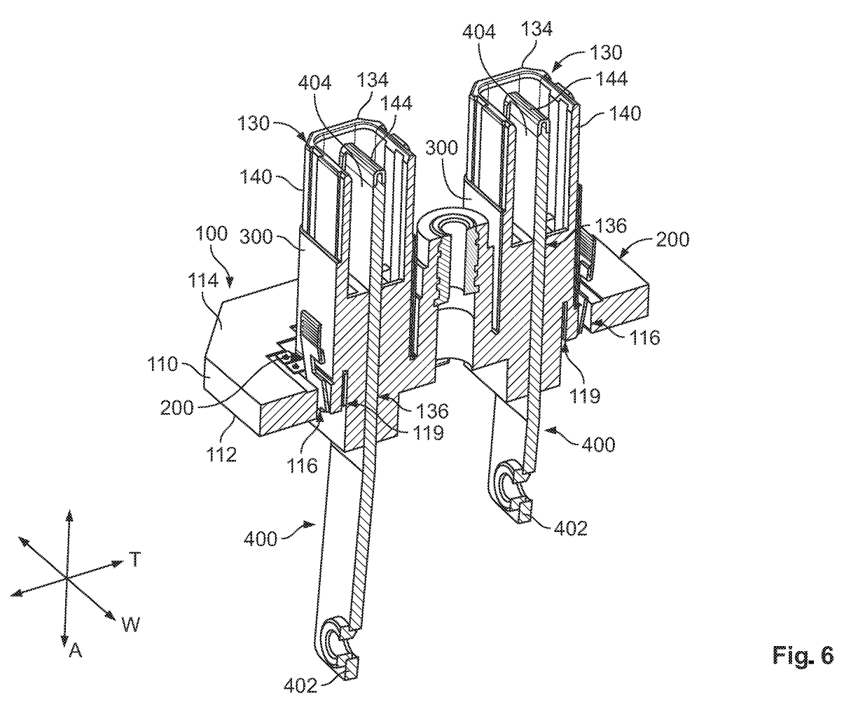

The header assembly 10, in an embodiment shown in FIG. 6, includes a shield 300 positioned around each of the terminal blocks 130 of the backing plate 100. The shield 300 may be formed of a sheet of conductive material, such as a metal. The shield 300 is bent around the terminal block 130 and is attached to the base 110. The number of shields 300 corresponds to the number of terminal blocks 130 of the backing plate 100.

As shown in FIGS. 1, 6, and 10, the header assembly 10 includes a terminal 400 positioned and held in each of the terminal blocks 130. The number of terminals 400 may be different in other embodiments of the header assembly 10, provided that the number of terminals 400 corresponds to the number of terminal blocks 130. The terminals 400 each extend from a connection end 402 to a mating end 404 along the assembly direction A. In the shown embodiment, the terminals 400 are each a solid bar of conductive material with a rectangular cross-section. In other embodiments, the terminals 400 may be any form of conductive material used as a terminal in an electrical connector.

As shown in FIG. 6, each of the terminals 400 is positioned and held in the terminal receiving passageway 136 of one of the terminal blocks 130. The connection end 402 is positioned below the first side 112 of the base 110 in the assembly direction A and the mating end 404 is positioned within the terminal shroud 140 adjacent to the second end 134 of the terminal block 130. In the shown embodiment, the mating end 404 of the terminal 400 is surrounded by the touch protection 144.

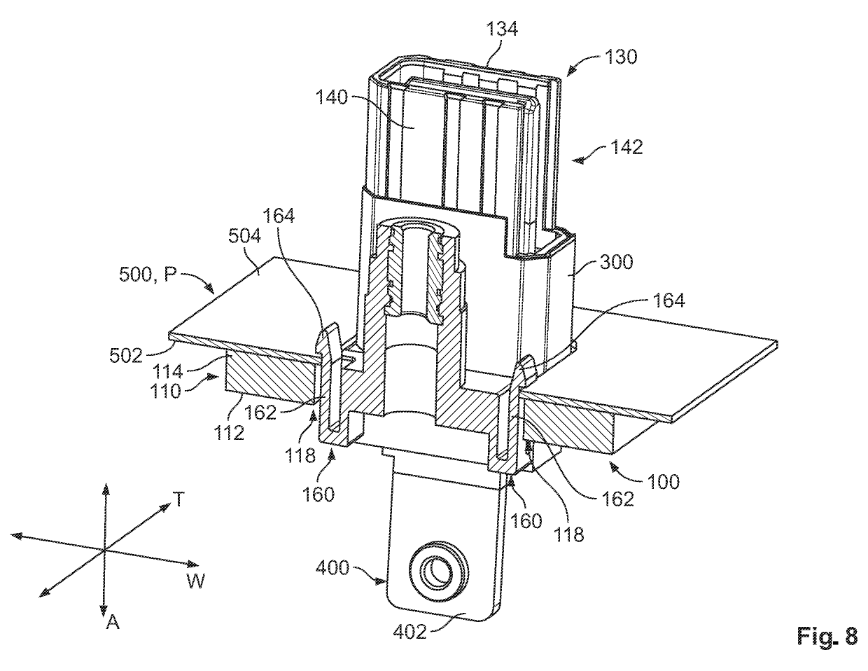

With the locking clips 200 attached to the backing plate 100 as described above, the interface plate 500 is attached as shown in FIGS. 7 and 8. The interface plate 500 is positioned around the terminal blocks 130 and, as the interface plate 500 is moved toward the base 110 of the backing plate 100 in the assembly direction A, the terminal blocks 130 are received in the plate opening 506 of the interface plate 500.

As the interface plate 500 moves along the assembly direction A, the interface plate 500 abuts the latch protrusions 164 of the latches 160 and deflects the latches 160 inward along the width direction W. When the interface plate 500 reaches the position shown in FIG. 8, in which the first face 502 of the interface plate 500 abuts the second side 114 of the base 110, the second face 504 of the interface plate 500 is below the latch protrusions 164 and the latches 160 resiliently return to engage the interface plate 500, securing the interface plate 500 to the base 110 of the backing plate 100 in a latched position P. In the latched position P, the latch protrusion 164 engages the second face 504 of the interface plate 500 opposite the base 110.

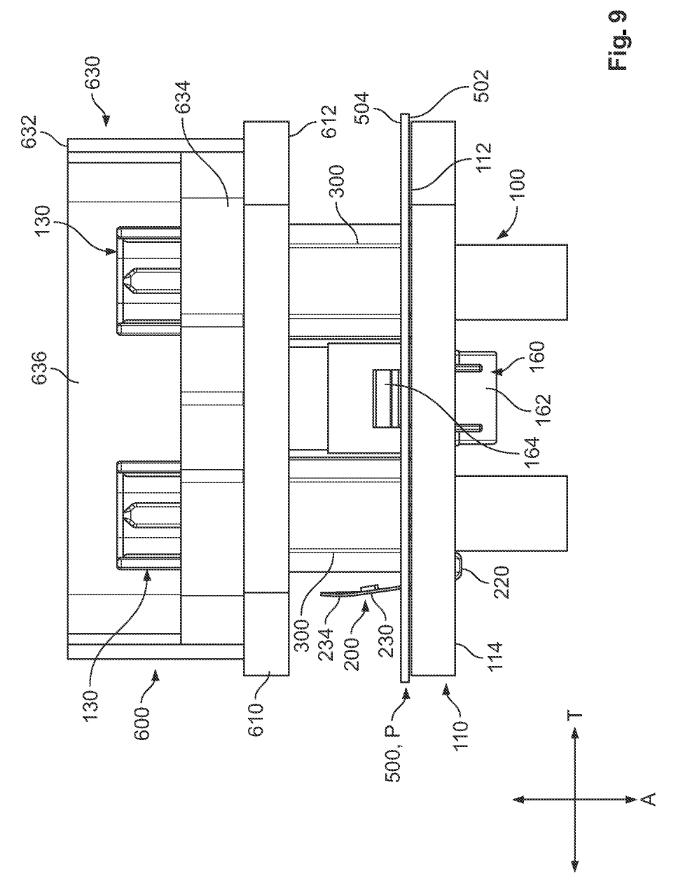

The latches 160 releasably secure the interface plate 500 to the backing plate 100 in the latched position P shown in FIG. 8. With the interface plate 500 secured to the backing plate 100, the clip arms 230 of the locking clips 200 extend through the base 110 of the backing plate 100 and through the plate opening 506 of the interface plate 500; the free end 234 of the clip arms 230 is positioned beyond the second face 504 of the interface plate 500, as shown in FIG. 9. FIG. 9 shows only one of the locking clips 200 for clarity of the drawings, but two locking clips 200 are present as shown in FIGS. 6 and 10.

With the interface plate 500 in the latched position P, the header 600 is moved from a position shown in FIG. 9 to a locked position L shown in FIG. 10 that forms the header assembly 10.

The header 600 is positioned around the terminal blocks 130 as shown in FIG. 9, in an embodiment by using a dummy plug engaging with the terminal blocks 130, and is moved toward the base 110 and the interface plate 500 along the assembly direction A. As the header 600 moves toward the base 110, the protrusions 616 of the header 600, shown in FIG. 10, abut the free ends 234 of the locking clip 200 and deflect the clip arms 230 inward along the transverse direction T. When the header 600 reaches the locked position L shown in FIG. 10, the clip arms 230 resilient return and the locking clips 200 releasably lock the header 600 to the backing plate 100 and the interface plate 500. The header 600 in the locked position L is disposed on the interface plate 500 and on the base 110 around the terminal blocks 130. The interface plate 500 is secured and disposed between the backing plate 100 and the header 600 in the locked position L.

In the locked position L, as shown in FIG. 10, each of the protrusions 616 of the header 600 is disposed and engaged in the locking opening 238 of one of the clip arms 230 to releasably attach the header 600 to the backing plate 100 and the interface plate 500. The bottom face 612 of the flange 610 abuts and is secured against the second face 504 of the interface plate 500. In the locked position L, the seal 650 is resiliently compressed between the flange 610 and the interface plate 500 to form a seal between the header 600 and the interface plate 500.

In the locked position L, the header shroud 630 surrounds the terminal blocks 130, as shown in FIGS. 1 and 10. The first section 634 of the header shroud 630 is aligned with the open side 142 of the terminal shroud 140 along the width direction W and the second section 636 of the header shroud 630 extends around and is spaced apart from the remaining sides of the terminal shroud 140 of the terminal blocks 130.

In the header assembly 10 according to the embodiments described above, the assembly simply requires inserting components along the clip direction C and the assembly direction A to create multiple latches that secure the components together. This assembly process is simple and can be easily integrated into an automated assembly process, improving assembly efficiency. As shown in FIG. 10, the free ends 234 of the clip arms 230 are also accessible from the mating end 632 of the header 600 in the locked position L. To release the header 600 from the backing plate 100 and the interface plate 500, for example to service the header 600, a user can deflect the locking clips 200 inward with only a tool that extends into the mating end 632, allowing simple disassembly for maintenance. The locking clips 200 formed of a resilient material further allow for a long-term, robust securing of the locked position L under varying load conditions, without increasing the overall size of the header assembly 10.

1. A header assembly, comprising:
a backing plate having a base and a terminal block extending from the base;
a locking clip having an attachment section attached to the backing plate and a clip arm extending away from the attachment section; and
a header disposed on the base around the terminal block of the backing plate, the clip arm of the locking clip releasably engages the header to attach the header to the backing plate in a locked position.

2. The header assembly of claim 1, further comprising an interface plate disposed between the backing plate and the header in the locked position.

3. The header assembly of claim 2, wherein the interface plate has a plate opening extending through the interface plate, the terminal block of the backing plate is received in the plate opening.

4. The header assembly of claim 3, wherein the clip arm of the locking clip extends through the base of the backing plate and through the plate opening of the interface plate.

5. The header assembly of claim 2, wherein the backing plate has a latch engaging the interface plate and securing the interface plate to the base of the backing plate in a latched position.

6. The header assembly of claim 5, wherein the latch has a latch arm extending from the base and a latch protrusion at an end of the latch arm, the latch protrusion engages a face of the interface plate opposite the base in the latched position.

7. The header assembly of claim 6, wherein the latch is monolithically formed in a single piece with the base and extends through a latch passageway extending through the base in an assembly direction.

8. The header assembly of claim 1, wherein the attachment section is attached to a first side of the base, the clip arm extends through a clip passageway that extends from the first side of the base to a second side of the base opposite the first side in an assembly direction.

9. The header assembly of claim 8, wherein the attachment section has a tab that is press-fit into a clip recess of the base.

10. The header assembly of claim 8, wherein the clip arm is cantilevered and has a free end extending beyond the second side of the base.

11. The header assembly of claim 10, wherein the locking clip has a connection section connecting the attachment section to the clip arm, the connection section extends around the first side of the base.

12. The header assembly of claim 1, wherein the header has a protrusion and the locking clip has a locking opening extending through the clip arm, the protrusion engages in the locking opening to attach the header to the backing plate in the locked position.

13. The header assembly of claim 2, wherein the header has a flange abutting the interface plate and a header shroud extending from the flange, the header shroud surrounds the terminal block in the locked position.

14. The header assembly of claim 13, wherein the flange has a seal recess extending into a bottom face of the header abutting the interface plate, the header has a seal disposed in the seal recess and compressed between the flange and the interface plate in the locked position.

15. The header assembly of claim 1, further comprising a terminal held in the terminal block.

16. The header assembly of claim 1, wherein the locking clip is formed of a metal material.

17. The header assembly of claim 16, wherein the backing plate and the header are each formed of an insulative material.

18. A method of assembling a header assembly, comprising:
providing a backing plate having a base and a terminal block extending from the base;
attaching a locking clip to the backing plate, the locking clip has an attachment section attached to the backing plate and a clip arm extending away from the attachment section; and
moving a header in an assembly direction around the terminal block of the backing plate, the clip arm releasably engages the header to attach the header to the backing plate in a locked position.

19. The method of claim 18, wherein the clip arm is accessible from a mating end of the header to release the attachment of the header to the backing plate.

20. The method of claim 18, further comprising positioning an interface plate around the terminal block before moving the header into engagement with the clip arm, the backing plate has a latch engaging the interface plate and securing the interface plate to the backing plate.
